(19) United States
(12) Patent Application Publication
(10) Pub. No.: US 2025/0173864 A1
(43) Pub. Date: May 29, 2025

(54) GENERATION METHOD, DISCRIMINATION METHOD, COMPUTER PROGRAM, GENERATION DEVICE, AND DISCRIMINATION DEVICE

(71) Applicants: LEF Technology, Inc., Tokyo (JP); Kanda System Co., Ltd., Tokyo (JP)

(72) Inventors: Naohiro ASAKA, Tokyo (JP); Toshiyuki IGATA, Kobe-shi (JP); Naoya AKASAKI, Tokyo (JP)

(21) Appl. No.: 18/956,557

(22) Filed: Nov. 22, 2024

(30) Foreign Application Priority Data
Nov. 24, 2023 (JP) 2023-199346

(51) Int. Cl. G06T 7/00; G06T 7/90

(52) U.S. Cl. CPC G06T 7/0012; G06T 7/90; G06T 2207/30188

(57) ABSTRACT

A generation method for a discriminant model for discriminating a growth state of a plant executed by a computer including an arithmetic circuit configured to access a storage device, the generation method comprising: storing, by the storage device, a chloroplast density image which is an image reflecting a difference between absorption spectra of chlorophyll and carotenoids contained in the plant obtained from a plurality of images of leaves of plants for training; being executed by the arithmetic circuit; reading the chloroplast density image from the storage device; and generating a discriminant model of the growth state of the plant using the chloroplast density image as training data for machine learning.

### CROSS-REFERENCE TO RELATED APPLICATIONS

This application claims the benefit of Japanese Patent Application No. 2023-199346 filed on Nov. 24, 2023, the content of which is incorporated herein by reference in its entirety.

### FIELD

The present disclosure relates to a generation method and a generation device of a discriminant model for discriminating a growth state of a plant, a discrimination method and a discrimination device for discriminating a growth state of a plant, and a computer program for executing these methods.

### BACKGROUND

A growth state of a plant may be observed from a raw leaf of the plant. For example, JP2013-36889 A describes an apparatus that irradiates a leaf of a plant with excitation light to diagnose whether the plant is infected with pathogenic bacteria.

### SUMMARY

However, there is still room for improvement in terms of easily observing and accurately observing the growth state of a plant.

Therefore, an object of the present disclosure is to provide a generation method and a generation device of a discriminant model for discriminating a plant growth state, a discrimination method and a discrimination device for discriminating a plant growth state, and a computer program for executing these methods, which enable easy and/or accurate observation of a plant growth state.

### Means for Solving the Problems

A generation method according to the present disclosure generates a discriminant model for discriminating a growth state of a plant executed by a computer including an arithmetic circuit accessible to a storage device. The storage device stores a chloroplast density image which is an image reflecting a difference between absorption spectra of chlorophyll and carotenoids contained in the plant leaf obtained from a plurality of images of plant leaves for training. The generation method is executed by the arithmetic circuit, reads the chloroplast density image from the storage device, and generates a discriminant model of a plant growth state by using the chloroplast density image as training data for machine learning.

Such general and specific aspects may be implemented by a system, a method, a computer program, and a combination thereof.

A generation method and a generation device of a discriminant model for discriminating a growth state of a plant according to the present disclosure, a discrimination method and a discrimination device for discriminating a growth state of a plant, and a computer program for executing these methods provide easy and/or accurate observation of the growth state of the plant.

### BRIEF DESCRIPTION OF THE DRAWINGS

FIG. 1A A model of an emission spectrum of a white LED.

FIG. 1B A model of an absorption spectrum of chlorophyll.

FIG. 1C A model of an absorption spectrum of the carotenoid.

FIG. 1D A model of an action spectrum of chlorophyll.

FIG. 2A A model of a spectrum of a healthy portion.

FIG. 2B A model of a spectrum of a yellowing portion.

FIG. 2C A model of a spectrum of a leaf-vein portion.

FIG. 3A A model of a spectral sensitivity curve of R of a digital camera.

FIG. 3B A model of a spectral sensitivity curve of G of a digital camera.

FIG. 3C A model of a spectral sensitivity curve of B of a digital camera.

FIG. 4 The difference between the model spectrum of the yellowing portion and the model spectrum of the healthy portion.

FIG. 5A An image obtained by photographing the surface of a leaf.

FIG. 5B A binarized image of an image obtained by monochromatizing the image in FIG. 2A.

FIG. 5C A binarized image of a chloroplast density image obtained using the R image and the B image obtained from the image in FIG. 2A.

FIG. 6A A schematic diagram illustrating generation of a discriminant model.

FIG. 6B A schematic diagram illustrating discrimination using a discriminant model.

FIG. 7 A block diagram showing an example of a generation device according to a first exemplary embodiment.

FIG. 8 A block diagram showing an example of a discrimination device according to the first exemplary embodiment.

FIG. 9 A flowchart showing an example of processing of generating a discriminant model executed by the generation device according to the first exemplary embodiment.

FIG. 10 A flowchart showing an example of discrimination processing executed by the discrimination device according to the first exemplary embodiment.

FIG. 11 A block diagram showing an example of a generation device according to a second exemplary embodiment.

FIG. 12A A schematic diagram illustrating clustering data.

FIG. 12B A schematic diagram illustrating a clustering result.

FIG. 12C A schematic diagram illustrating a clustering result.

FIG. 13 A flowchart showing an example of processing of clustering and generating a discriminant model executed by the generation device according to the second exemplary embodiment.

FIG. 14 A schematic diagram showing an example of data used in Experimental Example 1.

FIG. 15 A schematic diagram showing an example of training data and evaluation data each selected for the first time to the ninth time from the group in FIG. 14.

FIG. 16 A graph showing results of Experimental Example 3.

### MODE FOR CARRYING OUT THE INVENTION

Hereinafter, exemplary embodiments of the present disclosure will be described with reference to the drawings. However, in the detailed description, unnecessary parts in the description of the conventional technique and substantially the same configuration may be omitted. This is to simplify the description. In addition, the following description and the accompanying drawings are disclosed so that those skilled in the art can fully understand the present disclosure, and are not intended to limit the subject matter of the claims.

The present disclosure relates to a generation method and a discrimination method for a discriminant model for discriminating a growth state of a plant. Hereinafter, as a growth state of a plant, generation and use of a discriminant model for discriminating a healthy growth state of a plant will be described as an example. More specifically, an example in which a disease of a plant appears as leaf yellowing will be described.

### <Growth State of Plant>

A growth state of a plant may appear on a leaf of the plant. For example, whether a plant is in a healthy state or a state of being infected with a disease may be determined by the external appearance of the leaf. On the other hand, even when the plant is healthy, at first glance, the plant may appear in a growth state similar to when the plant is infected with a disease.

For example, when a plant is infected with a disease, the leaves of the plant may turn yellow. Thus, a plant grower may determine that the plant is infected with a disease when the leaves of the plant turn yellow. On the other hand, even when the plant is not infected with a disease, the leaves of the plant may turn yellow. For example, when a plant is under conditions such as nutritional deficiency and insufficient sunlight, the leaves may turn yellow even when the plant is not infected with a disease. In such a case, it may be difficult for even an expert to determine whether the plant is infected with a disease or not.

Dealing with the plant is different depending on when the plant is not infected with a disease and when the plant is infected with a disease. Therefore, it is desirable to improve the discrimination accuracy of whether a plant has been infected with a disease.

As the amount of chlorophyll changes, the leaf of the plant has a relatively high carotenoid density and yellows. There may be a difference in shape, distribution, shade, and the like between yellowing due to nutritional deficiency and yellowing due to disease damage. In some cases, only a skilled agricultural worker can recognize the difference in the yellowing portion.

Since plants perform photosynthesis, the mesophyll of a leaf contains photosynthetic pigments such as chlorophyll and carotenoids possessed by chloroplasts. The chlorophyll possessed by chloroplasts is one of the main photosynthetic pigments, and the carotenoid is one of the auxiliary photosynthetic pigments.

When the plant is not affected by diseases due to viral infection or the like and the growth is good, that is, when the plant is healthy, the mesophyll of the leaf contains sufficient chlorophyll and carotenoid. Hereinafter, a portion sufficiently containing the chlorophyll and the carotenoid as described above is also referred to as a “healthy portion”.

When a plant is affected with disease damage or nutritional deficiency, the development of chloroplasts in the mesophyll deteriorates, the chlorophyll decreases, and the leaves turn yellow. Hereinafter, such a portion is referred to as a “yellowing portion”. That is, the yellowing portion may be “caused by being affected with disease damage” or “caused by something other than being affected with disease damage”.

It should be noted that the leaf vein of the leaf is normally low in or free of chlorophyll and carotenoids.

Therefore, the amount of chlorophyll and carotenoids in each portion is as in Table 1 below.

TABLE 1

| | CHLOROPHYLL | CAROTENOID |
|---|---|---|
| | AMOUNT | CONTENT |
| HEALTHY | LARGE | LARGE |
| PORTION | | |
| YELLOWING | SMALL | LARGE |
| PORTION | | |
| LEAF VEIN | SMALL/NOT | SMALL/NOT |
| | CONTAINED | CONTAINED |

Here, as described above, the yellowing portion may be “caused by being affected with disease damage” or “caused by something other than being affected with disease damage”. Depending on this cause, the distribution of chlorophyll on the surface of the leaf containing the yellowing portion varies. In other words, the shape, shade, and distribution of the yellowing portion caused by the decrease in the chlorophyll amount are different. If the aspect of the distribution of chlorophyll, which cannot be easily distinguished by such appearance, can be discriminated, it can be distinguished whether the cause of yellowing is “disease damage” or “other”. For example, when the shape of the yellowing portion, the distribution in the leaves, and the shade can be easily distinguished, the accuracy of discrimination can be improved.

### <Transmission of Light in Chloroplast>

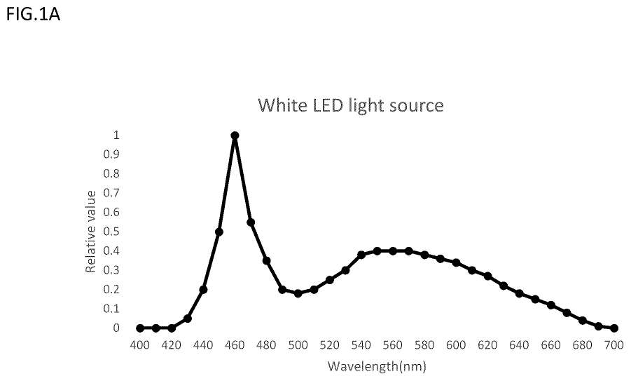

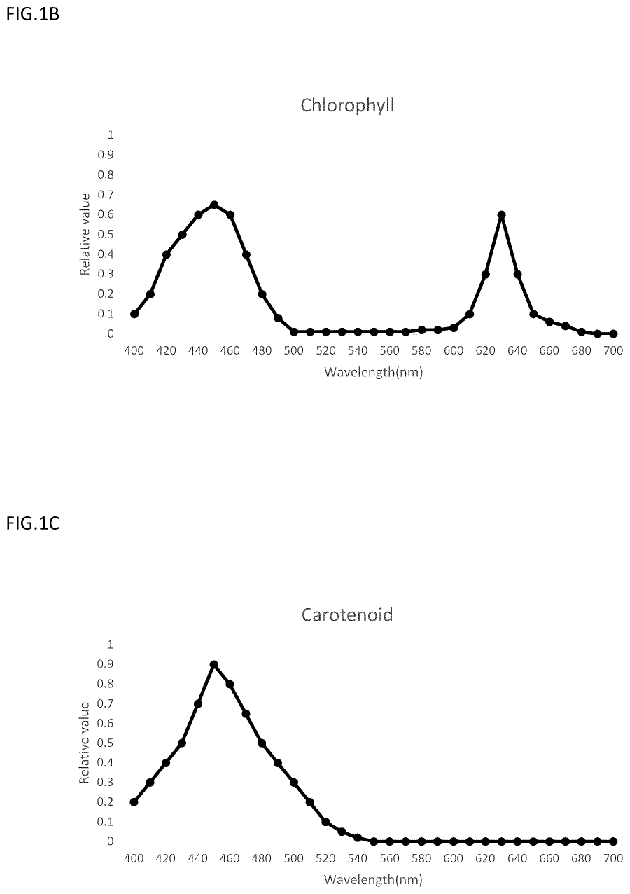

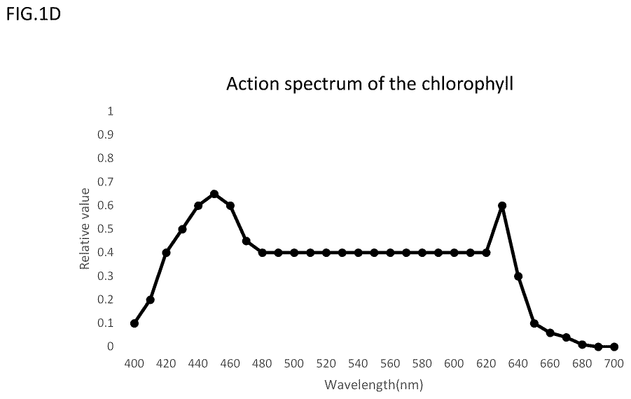

Next, light transmission of chlorophyll and carotenoids will be described. As an example, a case where a white LED is used for a light source will be considered. FIG. 1A shows a model of the emission spectrum of a white LED. FIG. 1B shows a model of the absorption spectrum of chlorophyll. FIG. 1C shows a model of the absorption spectrum of the carotenoid.

However, the absorbance shown in FIGS. 1B and 1C is ideally measured in the solution, and actually, light that has entered the leaf is internally scattered in the leaf, and thus even green light can be absorbed by the chloroplast or other substances in the leaf and contribute to photosynthesis. This effect can be seen in the form of an action spectrum of photosynthesis as shown in FIG. 1D, for example.

As described above, since the absorption effect of green light largely depends on internal scattering in leaves, it is known that a thin plant such as sea lettuce has a photosynthesis action spectrum close to the ideal absorption spectrum of chlorophyll. Whatever the substance that absorbs the green light, since the green light absorption effect is largely due to an increase in the encounter probability between the incident light and the light-absorbing substance brought about by the internal scattering effect due to the presence of the chloroplast, when the chloroplast disappears due to yellowing of the leaf, the green light absorption effect is also weakened. In that sense, here, the action spectrum in FIG. 1D is adopted as the action spectrum of the chlorophyll for convenience. In addition, regarding the carotenoids, FIG. 1 is adopted as it is.

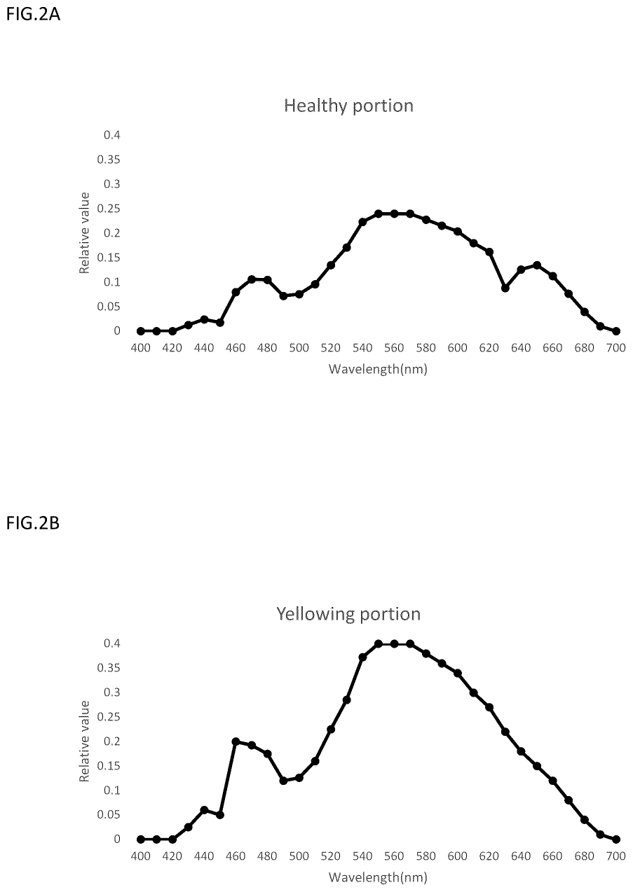

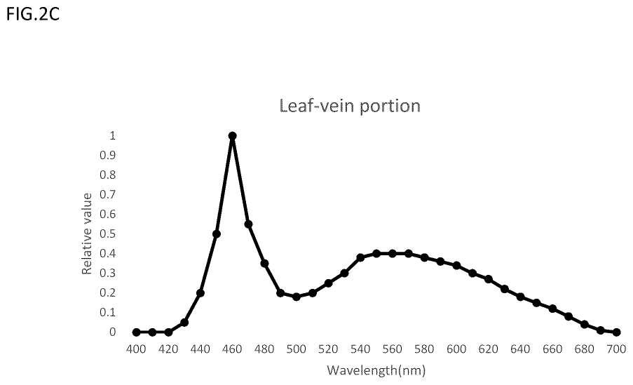

According to Table 1, an absorption spectrum is caused to act on the light of a light source under each condition. That is, the absorption spectrum of chlorophyll shown in FIG. 1B and the absorption spectrum of carotenoids shown in FIG. 1C are caused to act on the healthy portion. Only the absorption spectrum of the carotenoid shown in FIG. 1C is caused to act on the yellowing portion. Neither the absorption spectrum of chlorophyll nor the absorption spectrum of carotenoids is caused to act on the leaf-vein portion. FIG. 2A shows the result of the healthy portion (the model of the spectrum of the healthy portion), FIG. 2B shows the result of the yellowing portion (the model of the spectrum of the yellowing portion), and FIG. 2C shows the result of the leaf-vein portion (the model of the spectrum of the leaf-vein portion).

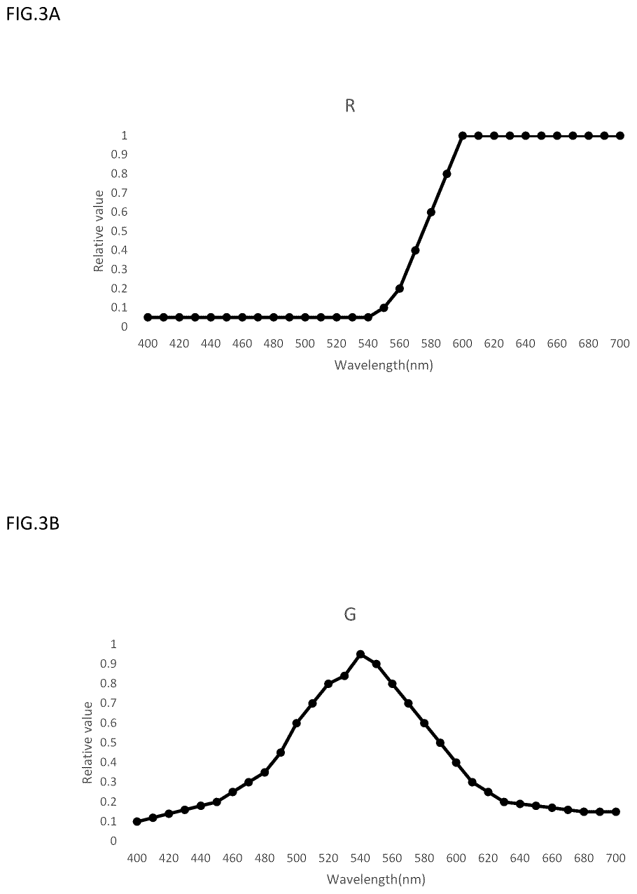

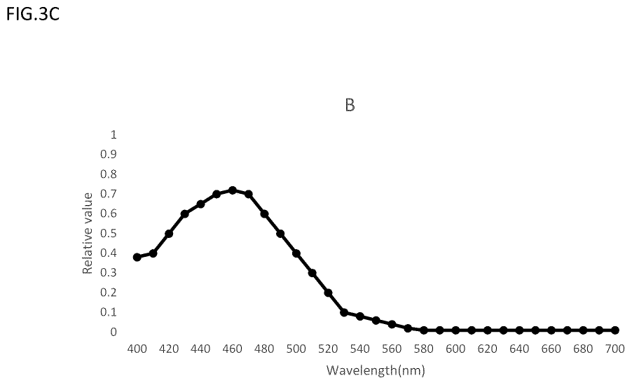

Next, the spectral sensitivity curve of the digital camera is caused to act on these spectral groups. That is, these spectral groups are divided into three colors of RGB, but there is no wavelength information at the time of spectral separation, and an integrated pixel value remains. It should be noted that a minimum element that is arranged in a grid shape and constitutes an image is referred to as a pixel. Each pixel represents the intensity and color of light by a numerical value. In addition, a value representing the intensity and color of light of each pixel is referred to as a pixel value. FIG. 3A shows a model of a spectral sensitivity curve of R. FIG. 3B shows a model of a spectral sensitivity curve of G. FIG. 3C shows a model of a spectral sensitivity curve of B.

Table 2.1 shows an example of pixel values representing the intensity of each light of the healthy portion, the yellowing portion, and the leaf-vein portion when each light of R, G, and B is acted. According to Table 2.1, it can be seen that the leaf-vein portion has the highest value in any case of R, G, and B, and the yellowing portion cannot be emphasized. In addition, when comparing the respective pixel values, it can be seen that the leaf-vein portion has a high value in all the bands of the R image, the G image, and the B image, whereas the B image has a lower value than the R image and the G image in the healthy portion and the yellowing portion.

TABLE 2.1

| | HEALTHY | YELLOWING | LEAF-VEIN |
|---|---|---|---|
| | PORTION | PORTION | PORTION |
| R | 1.67 | 2.61 | 2.71 |
| G | 1.81 | 3.02 | 3.64 |
| B | 0.43 | 0.81 | 2.24 |

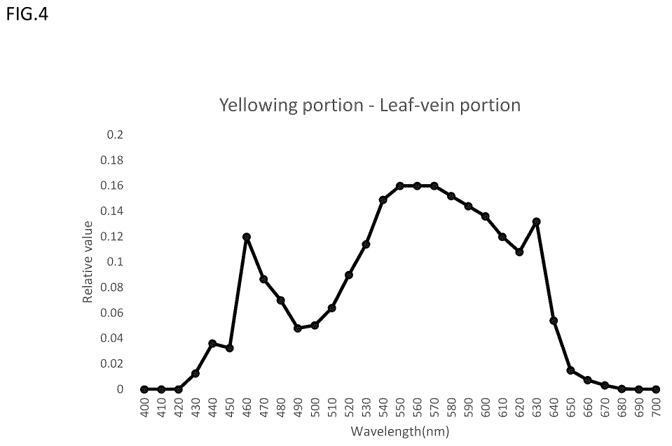

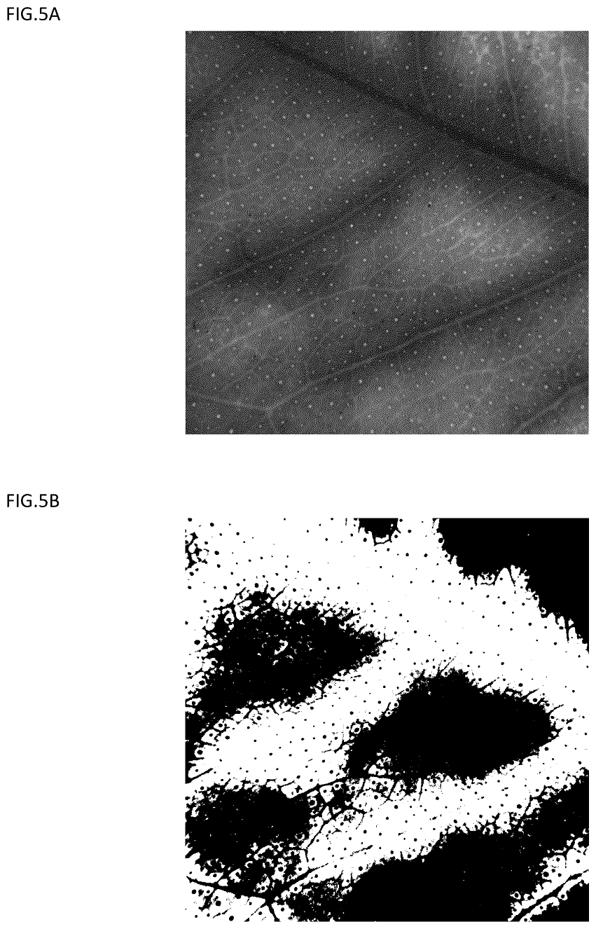

FIG. 4 shows the difference between the model spectrum of the yellowing portion and the model spectrum of the healthy portion. Specifically, it is a graph showing a value obtained by subtracting the model spectrum of FIG. 2A from the model spectrum of FIG. 2B. In FIG. 4, it can be seen that the difference is larger on the medium wavelength side (for example, about 500 nm to 600 nm) and the long wavelength side (for example, about 600 nm to 780 nm) than on the short wavelength side (for example, about 400 nm to 500 nm). That is, there is a large difference in the wavelength portion distributed extending across G (green light: for example, medium wavelength) and R (red light: for example, long wavelength), and the difference between the yellowing portion and the healthy portion is relatively small in the wavelength band counted as B (blue light: for example, short wavelength). This is clear even when the difference between the values of the yellowing portion and the healthy portion is calculated in each of the pixel values of R, G, and B in the above matrix.

From the above contents, the following two points can be said.

The difference between the yellowing portion and the healthy portion appears in the pixel value of the wavelength band extending across R and G.

The leaf-vein portion has high pixel values in wavelength bands of all RGB.

From this, it can be said that Expression (1.1) is the optimum calculation expression to maximally emphasize the “difference between the yellowing portion and the healthy portion”, that is, the “density of chloroplasts”.

(Expression for blending R image and G image with any weighting)−(Expression using B image) (1.1)

where, (Expression for blending R image and G image with any weighting) includes an arithmetic mean, a geometric mean, and other expressions capable of weighting with two elements. A coefficient or a correction term may be used in (Expression using B image) so that the effect of removing the leaf vein is enhanced, for example. To finally output the chloroplast density image as a monochrome image, (Expression for blending R image and G image with any weighting) and (Expression using B image) may be normalized to equalize the maximum and minimum ranges of both.

In the first term of the above Expression (1.1), the difference between the yellowing portion and the healthy portion becomes clear. In the second term of Expression (1.1), information on the leaf-vein portion is cut. Here, the maximum and minimum ranges of the first term and the second term in Expression (1.1) need to be the same. In general, the pixel value of each of RGB takes values from 0 to 255. Therefore, the first term of Expression (1.1) is Expression (1.2).

$$( R image \times x + G image \times y ) / ( x + y ) \qquad ( 1.2 )$$

$$( where 0 \leq x , 0 \leq y )$$

Here, the reason why the values of x and y are not uniquely determined is that the action spectrum of photosynthesis varies depending on plant leaves. It varies depending on the type of plant that which of R and G to be weighted further emphasizes the difference between the yellowing portion and the healthy portion.

Table 2.2 shows an example of the integrated pixel values of the healthy portion, the yellowing portion, and the leaf-vein portion when the respective x and y values of the following Expression (1.3) are (0, 1), (1, 0), and (1, 1). In all cases, it can be seen that the yellowing portion has the maximum pixel value, and the yellowing portion is most emphasized in the monochrome image.

$$( R image \times x + G image \times y ) / ( x + y ) - B image \qquad ( 1.3 )$$

$$( where 0 \leq x , 0 \leq y )$$

The image obtained by Expression (1.3) is an example of the “chloroplast density image” in the present disclosure.

TABLE 2.2

| | | HEALTHY | YELLOWING | LEAF-VEIN |
|---|---|---|---|---|
| x, y | EXPRESSION (1.3) | PORTION | PORTION | PORTION |
| 0, 1 | G IMAGE − B IMAGE | 1.38 | 2.21 | 1.40 |
| 1, 0 | R IMAGE − B IMAGE | 1.24 | 1.80 | 0.47 |
| 1, 1 | (R IMAGE + G IMAGE)/ | 1.31 | 2.00 | 0.94 |
| | 2 − B IMAGE | | | |

### <Chloroplast Density Image>

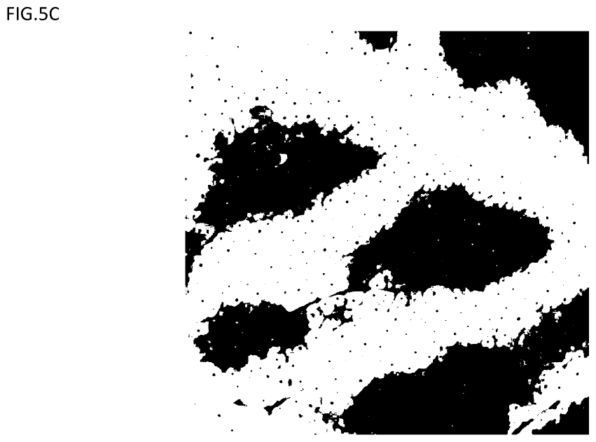

Here, the chloroplast density image used in the discriminant model of the present disclosure will be described with reference to FIGS. 5A to 5C. FIG. 5A is an image obtained by photographing the surface of a leaf. Actually, FIG. 5A shows a monochrome image, but actually is a color image.

FIG. 5B is an image obtained by binarizing, with a predetermined threshold value, the image obtained by converting FIG. 5A into a monochrome image. The threshold value was determined while adjusting so that the yellowing portion can be extracted. In the image in FIG. 5B, a black portion is mainly a yellowing portion. However, in the image in FIG. 5B, a leaf-vein portion and the like which do not turn yellow are also detected in black.

FIG. 5C shows an example of an image obtained by binarizing, while adjusting a threshold value so that a yellowing portion can be extracted, a chloroplast density image obtained by using the R image and the B image obtained using the color image in FIG. 5A. Specifically, the image in FIG. 5C is an image obtained by binarizing a chloroplast density image when the respective values of x and y are set as (1, 0) in the following Expression (1.3).

$$( R image \times x + G image \times y ) / ( x + y ) - B image \qquad ( 1.3 )$$

Also in the image in FIG. 5C, the black portion is mainly the yellowing portion. When the binarized image in FIG. 5B is compared with the image obtained by binarizing the chloroplast density image in FIG. 5C, the image obtained by binarizing the chloroplast density image in FIG. 5C can reduce the extraction of the leaf-vein portion as yellowing. As described above, the leaf-vein reduction effect (the effect of cutting the information on the leaf-vein portion) is exhibited.

### <Discriminant Model>

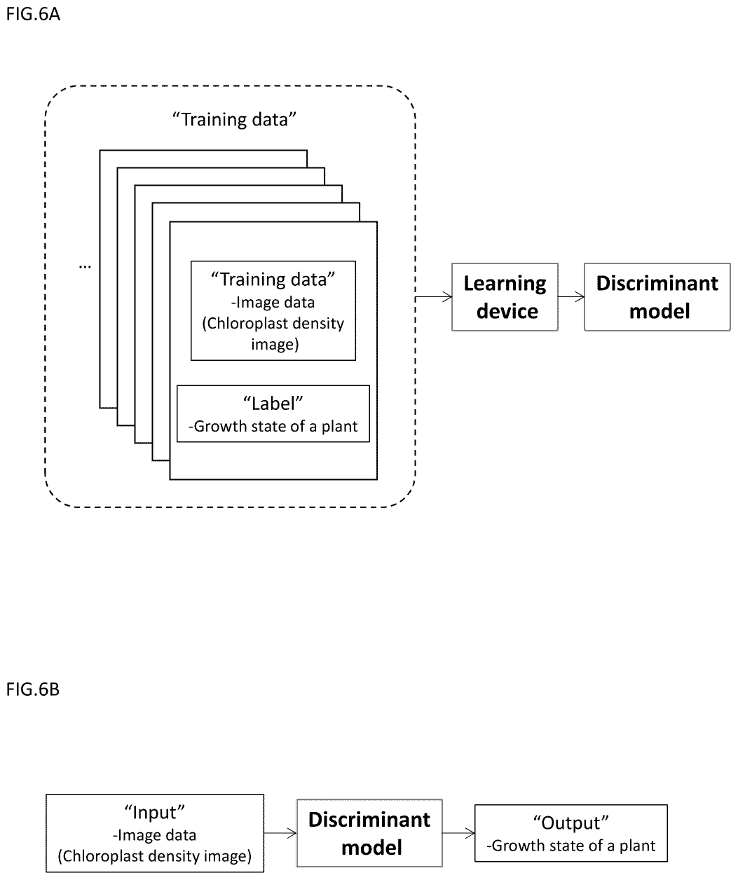

A discriminant model M for discriminating the growth state of a plant will be briefly described with reference to FIGS. 6A and 6B. As shown in FIG. 6A, the training data D13 used to generate the discriminant model includes a plurality of sets of image data and a label given to the image. Each piece of image data is a “chloroplast density image of a leaf of a plant”. In addition, the label is “a growth state of a plant” corresponding to each piece of image data. Specifically, the growth state of a plant is at least one of a disease-damage affected state, a nutritional deficiency/excess state, a poor growth environment state (inappropriate sunshine, temperature, humidity, and watering), and an insect-damage state, which may affect the health state and leaf color.

In the learning device, the relationship between each piece of image data included in the training data D13 and the growth state of the plant is learned by machine learning, and the discriminant model M is generated. When an image indicating the density of a plant is newly input, the discriminant model M outputs a growth state of the plant which is a discrimination result. If the growth state of the plant, which is the label, is “good” and “poor”, the discriminant model M outputs, for example, a possibility that the plant is “good” or “poor” to the input image indicating density of the plant. The label indicating the growth state of the plant is not limited to the two types of “good” and “poor”. For example, the growth state of the plant may be represented by three or more types of labels. By using the discriminant model M, it is possible to easily discriminate a plant that is difficult only by visual observation.

It should be noted that each piece of image data (chloroplast density image) is, for example, data generated from image data obtained by photographing the surface of a leaf of a plant. It should be noted that the image data included in one training data set is preferably photographed and generated under the same condition. For example, image data (chloroplast density image) included in one training data set can be generated by image data obtained by photographing under the same or similar light irradiation conditions. More specifically, the image data can be image data captured using a transmission-type optical system incorporating a surface light source having luminance substantially uniform with respect to a surface. In addition, the image data (chloroplast density image) included in one training data set is generated from the photographed data by the same method (arithmetic expression). As described above, the same or similar training data and discrimination data are captured under the same condition, thereby enabling accurate discrimination.

If images are photographed under a plurality of photographing conditions different in light irradiation conditions, there is a possibility that the light source spectrum and the spectral sensitivity curve are different. From the above discussion of the model spectrum, when the light irradiation conditions are different, it is not possible to uniquely determine the optimum values of x and y, which is inefficient. Therefore, by setting the training data and the discrimination data to the same or similar photographing conditions, more accurate discrimination can be made.

In addition, the above discussion of the model spectrum is based on the premise that imaging is performed so that a healthy (mesophyll) portion, a yellowing portion, and a leaf-vein portion of a leaf can be clearly distinguished. The present invention is a technique for further improving the discrimination accuracy of the discriminant model M on the premise that high-quality plant leaf photographed data is used. For example, by adopting a high-accuracy photographing environment such as a transmission-type optical system, it is possible to photograph a high-quality image of a plant leaf.

### <Configuration of Generation Device>

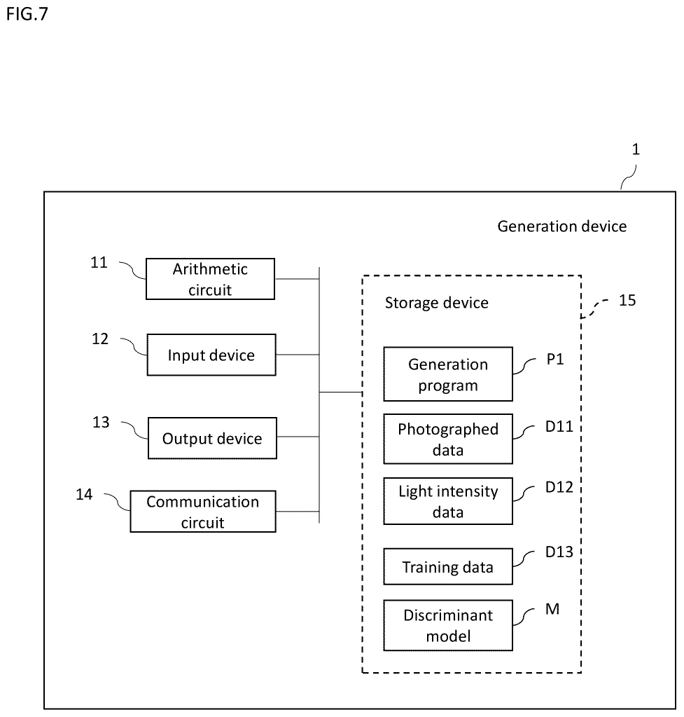

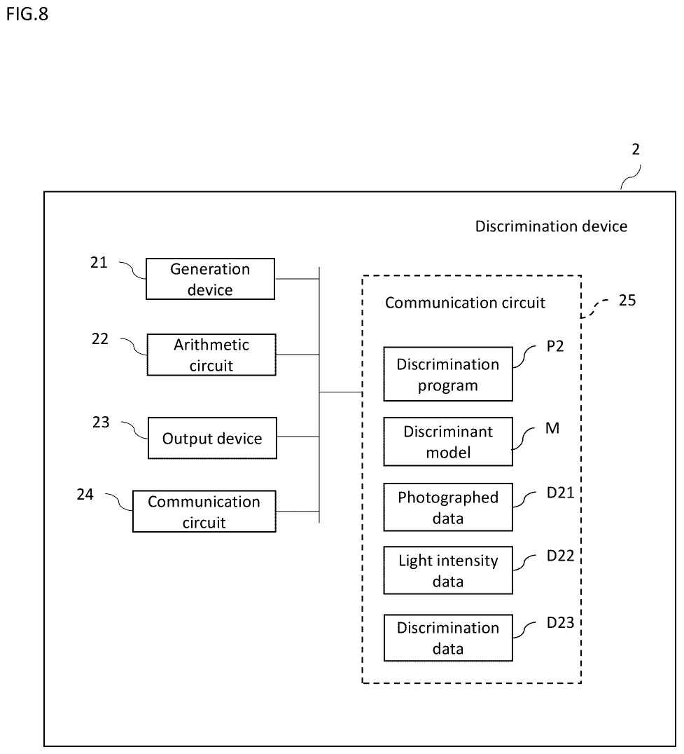

The configuration of the generation device 1 that generates the discriminant model M will be described with reference to FIG. 7. As shown in FIG. 7, the generation device 1 includes an arithmetic circuit 11, an input device 12, an output device 13, a communication circuit 14, a storage device 15, and the like. For example, the generation device 1 is a personal computer or an information processing device.

The arithmetic circuit 11 is a controller that takes charge of controlling the entire generation device 1. For example, the arithmetic circuit 11 reads and executes the generation program P1 stored in the storage device 15, thereby implementing various types of processing related to generation of the discriminant model M. The arithmetic circuit 11 may be various processors such as a CPU, an MPU, a GPU, an FPGA, a DSP, and an ASIC, or a dedicatedly designed hardware circuit.

The input device 12 is used for an operation or data input by the user. The input device 12 may be, for example, an operation button, a keyboard, a mouse, a touch panel, a microphone, or the like. The output device 13 is used for outputting processing results and data. The output device 13 may be an output means such as a display or a speaker, for example.

The communication circuit 14 performs data communication with other devices. The data communication is performed in a wired and/or wireless manner according to a known communication standard, for example. For example, wired data communication may be performed by using, as the communication circuit 14, a communication controller of a semiconductor integrated circuit that operates in conformity with the Ethernet (registered trademark) standard, the USB (registered trademark) standard, and/or the like. In addition, wireless data communication may be performed by using, as the communication circuit 14, a communication controller of a semiconductor integrated circuit that operates in conformity with IEEE 802.11 standards related to a wireless local area network (LAN) and/or a fourth/fifth/sixth generation mobile communication system, what is called 4G/5G/6G, related to mobile communication.

The storage device 15 is a recording medium that records various types of information. The storage device 15 is implemented by, for example, a RAM, a ROM, a flash memory, a solid-state drive (SSD), a hard disk drive, another storage device, or an appropriate combination thereof. The storage device 15 stores a generation program P1, photographed data D11, light intensity data D12, training data D13, discriminant model M, and the like. The generation program P1 is a computer program executed by the arithmetic circuit 11. By executing the generation program P1, various types of processing for generating the discriminant model M are executed.

The photographed data D11 is image data obtained by photographing a leaf of a plant.

The light intensity data D12 is data on the R image, the G image, and the B image generated from the photographed data D11.

As described above with reference to FIG. 6A, the training data D13 is data including a plurality of sets of the chloroplast density image and the label indicating the growth state of the corresponding plant. The chloroplast density image is generated from the light intensity data D12.

The discriminant model M is generated by the generation device 1 using the training data D13 as briefly described with reference to FIGS. 6A and 6B.

FIG. 7 shows an example in which the generation device 1 is implemented with one information processing device. However, the generation device 1 may be implemented with a plurality of information processing devices. For example, at least some of a plurality of pieces of processing to be executed may be executed by the arithmetic circuit. In addition, for example, at least some of the plurality of pieces of data may be stored in different storage devices.

By learning using the chloroplast density image to which the label indicating each state is attached, the generation device 1 can generate the discriminant model M for distinguishing and discriminating between “yellowing caused by being affected with disease damage” and “yellowing caused by something other than being affected with disease damage” described above in relation to Table 1. That is, “yellowing caused by being affected with disease damage” and “yellowing caused by something other than being affected with disease damage” are difficult to distinguish only by visual observation of the color image. However, by using the chloroplast density image indicating the density of chloroplasts obtained according to the amount of chlorophyll as training data, it is possible to distinguish “the degree of yellowing caused by being affected with disease damage” and “the degree of yellowing caused by something other than being affected with disease damage” which are difficult to distinguish by visual observation.

### <Configuration of Discrimination Device>

The configuration of the discrimination device 2 that discriminates the growth state of a plant using the discriminant model M will be described with reference to FIG. 8. As shown in FIG. 8, the discrimination device 2 includes an arithmetic circuit 21, an input device 22, an output device 23, a communication circuit 24, a storage device 25, and the like. For example, the discrimination device 2 is a personal computer or an information processing device.

The arithmetic circuit 21, the input device 22, the output device 23, the communication circuit 24, and the storage device 25 are implemented by specific means similar to the arithmetic circuit 11, the input device 12, the output device 13, the communication circuit 14, and the storage device 15 described above with reference to FIG. 8, respectively.

The storage device 25 stores a discrimination program P2, a discriminant model M, photographed data D21, light intensity data D22, discrimination data D23, and the like.

The discrimination program P2 is a computer program executed by the arithmetic circuit 21. By executing the discrimination program P2, various pieces of processing for discrimination are executed.

The discriminant model M is a trained model generated by the generation device 1 described above.

The photographed data D21 is image data of a leaf of a plant for discriminating a growth state.

The light intensity data D22 is data on the R image, the G image, and the B image generated from the photographed data D21.

The discrimination data D23 is a chloroplast density image obtained from the photographed data D21.

FIG. 8 shows an example in which the discrimination device 2 is implemented with one information processing device. However, the discrimination device 2 may be implemented with a plurality of information processing devices.

It should be noted that the discrimination device 2 shown in FIG. 8 may be implemented with the same device as the generation device 1 described above with reference to FIG. 7. That is, the generation of the discriminant model M and the discrimination of the growth state of the plant using the discriminant model M may be executed by the same information processing device.

### <Processing of Generating Discriminant Model>

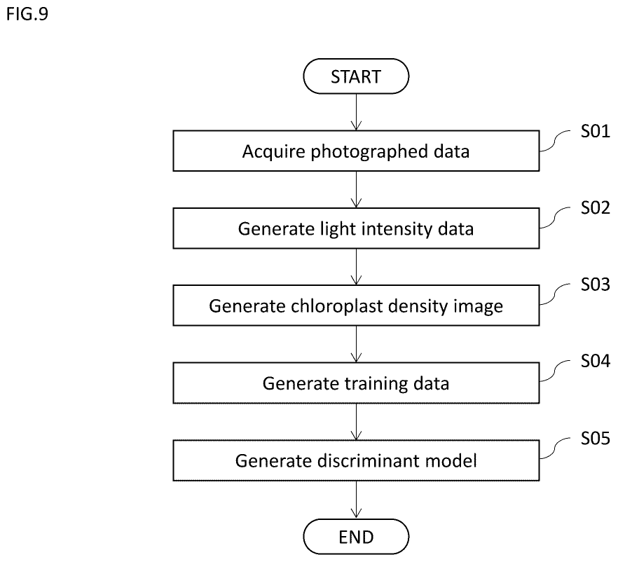

Processing of generating the discriminant model M executed by the generation device 1 will be described using a flowchart shown in FIG. 9.

First, the arithmetic circuit 11 acquires photographed data D11 of leaves of a plurality of plants (S01). The arithmetic circuit 11 stores the acquired plurality of pieces of photographed data D11 in the storage device 15. Here, a label indicating the growth state of the plant may be associated in advance with each piece of the photographed data D11. For example, labels such as “healthy”, “early stage of disease”, “middle stage of disease”, and “late stage of disease” are associated with each piece of photographed data D11. In addition, each piece of photographed data D11 is stored in the storage device 15 in association with a label indicating the growth state of the plant. It should be noted that when the label indicating the growth state of the plant is not associated with the photographed data D11 acquired in step S01, the arithmetic circuit 11 executes the labeling processing for each piece of photographed data D11.

The arithmetic circuit 11 generates light intensity data D12 using photographed data D11 acquired in step S01 (S02). Specifically, the arithmetic circuit 11 decomposes each piece of photographed data D11 into an R component, a G component, and a B component, and generates an R image indicating the intensity of red light, a G image indicating the intensity of green light, and a B image indicating the intensity of blue light, thereby generating a plurality of pieces of light intensity data D12. In addition, the arithmetic circuit 11 stores the generated light intensity data D12 in the storage device 15.

The arithmetic circuit 11 generates a chloroplast density image using light intensity data D12 generated in step S02 (S03). For example, the arithmetic circuit 11 generates a chloroplast density image by applying the following Expression (1.3) for each corresponding pixel of the image. The processing from step S02 to step S03 is what: is called preprocessing. Here, when another preprocessing is required before and after the processing of step S02 or step S03, the other preprocessing may be executed. For example, examples of preprocessing may include processing such as image trimming and image rotation.

$$( R image \times x + G image \times y ) / ( x + y ) - B image \qquad ( 1.3 )$$

$$( where 0 \leq x , 0 \leq y )$$

In one discriminant model, a chloroplast density image is acquired using the same arithmetic expression. Here, in Expression (1.3) or Expression (1.2) described above, all combinations of x and y that have the same expression when the fraction is reduced are defined to be the same. In other words, when the ratio of x and y is the same, it is defined as being the same. For example, combinations of x:y of 1:2, 2:4, and 3:6 are defined to be the same.

The arithmetic circuit 11 associates the corresponding label with each chloroplast density image generated in Step S03 to generate training data D13 (S04). In addition, the arithmetic circuit 11 stores the generated training data D13 in the storage device 15.

The arithmetic circuit 11 generates a discriminant model M using training data D13 generated in step S04 (S05). Specifically, the arithmetic circuit 11 learns a relationship between an image indicating the density of chloroplasts included in the training data D13 and a plant growth state to generate the discriminant model M. In addition, the arithmetic circuit 11 stores the generated discriminant model M in the storage device 15.

In this way, the generation device 1 can generate the discriminant model M for discriminating the growth state of the leaf of the plant from the image of the leaf of the plant.

### <Discrimination Processing Using Discriminant Model>

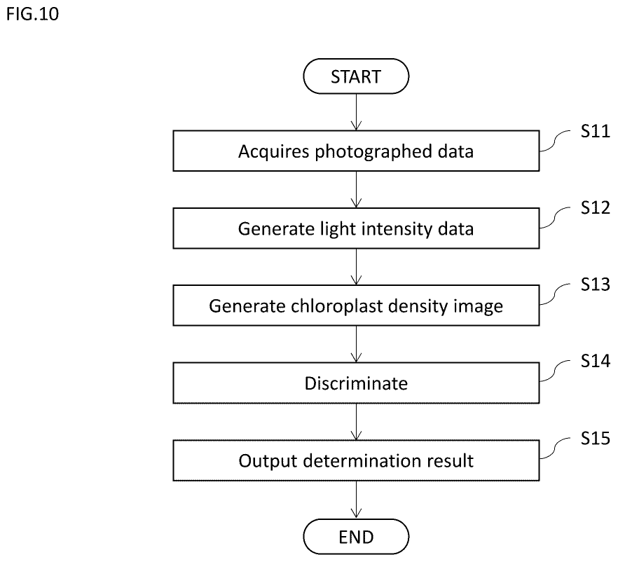

With reference to the flowchart shown in FIG. 10, processing of discriminating the growth state of the plant using the discriminant model M executed by the discrimination device 2 will be described.

The arithmetic circuit 21 first acquires photographed data on a leaf of a plant for determining a growth state (S11). The arithmetic circuit 21 stores the acquired photographed data D21 in the storage device 25.

The arithmetic circuit 21 generates light intensity data D22 using photographed data D21 acquired in step S11 (S12). The generation of the light intensity data D22 can be executed by processing similar to step S02 described above with reference to FIG. 6. In addition, the arithmetic circuit 21 stores the generated light intensity data D22 in the storage device 25.

The arithmetic circuit 21 generates a chloroplast density image using light intensity data D22 generated in step S12 (S13). The generation of the chloroplast density image can be executed by the same processing as step S03 described above with reference to FIG. 9. In addition, the arithmetic circuit 21 stores the generated chloroplast density image in the storage device 25 as the discrimination data D23.

The arithmetic circuit 21 discriminates the growth state of the target plant (S14) using the discrimination data D23 generated in step S13 as an input of the discriminant model M.

The arithmetic circuit 21 outputs the determination result in step S14 to the output device 23 (S15).

In this way, the discrimination device 2 can discriminate the growth state of the leaf of the plant from the image of the leaf of the plant using the discriminant model M.

### <<Determination of x and y Used in Expression (1.3)>>

The optimum values of x and y used in Expression (1.3) can be determined by feeding back and optimizing the discrimination accuracy obtained at that time. For example, the determination of the values of x and y used in Expression (1.3) may be executed in the generation device 1. At this time, the arithmetic circuit 11 can determine the values of x and y using a method used in a general optimization problem. The data used for determining the values of x and y is, for example, data associated with “photographed data” labeled with “healthy”, “early stage of disease”, “middle stage of disease”, and “late stage of disease” by an expert.

### Second Exemplary Embodiment

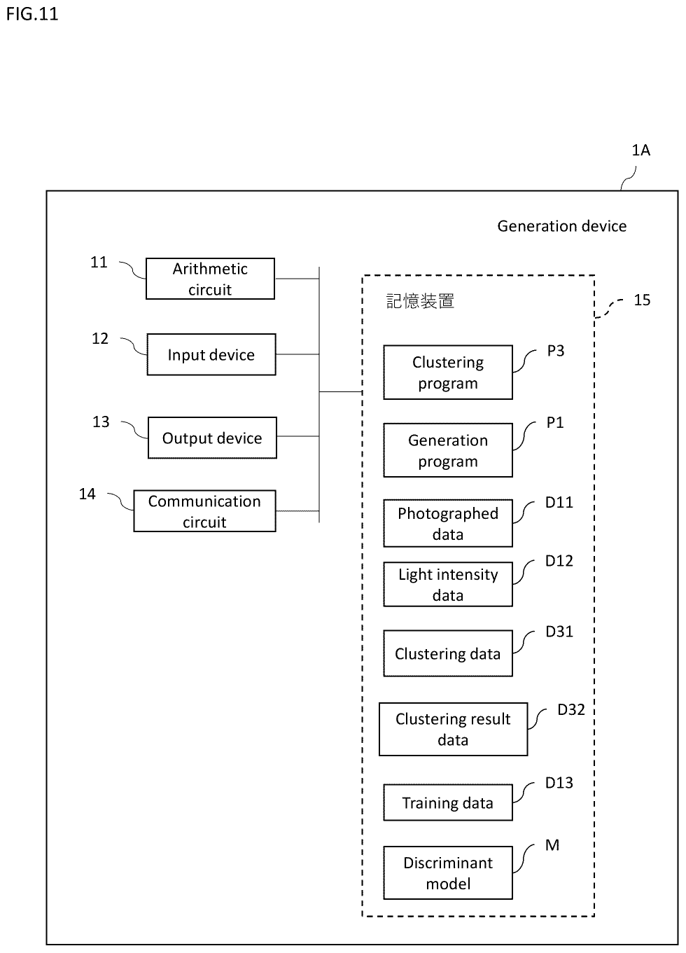

A generation device 1A according to a second exemplary embodiment will be described with reference to FIGS. 11 to 13. In the first exemplary embodiment described above, the example in which the generation device 1 generates the discriminant model M using supervised learning has been described. Specifically, the generation device 1 generates the discriminant model M using the training data D13 including an image previously labeled by preprocessing. On the other hand, the generation device 1A according to the second exemplary embodiment clusters unlabeled images using unsupervised learning. In addition, when receiving the label of each cluster generated by clustering, the generation device 1A generates training data and generates a discriminant model M. In the second exemplary embodiment, the same configuration and the same processing as those of the generation device 1 according to the first exemplary embodiment are denoted by the same reference numerals, and the description thereof may be omitted.

### <Configuration of Generation Device>

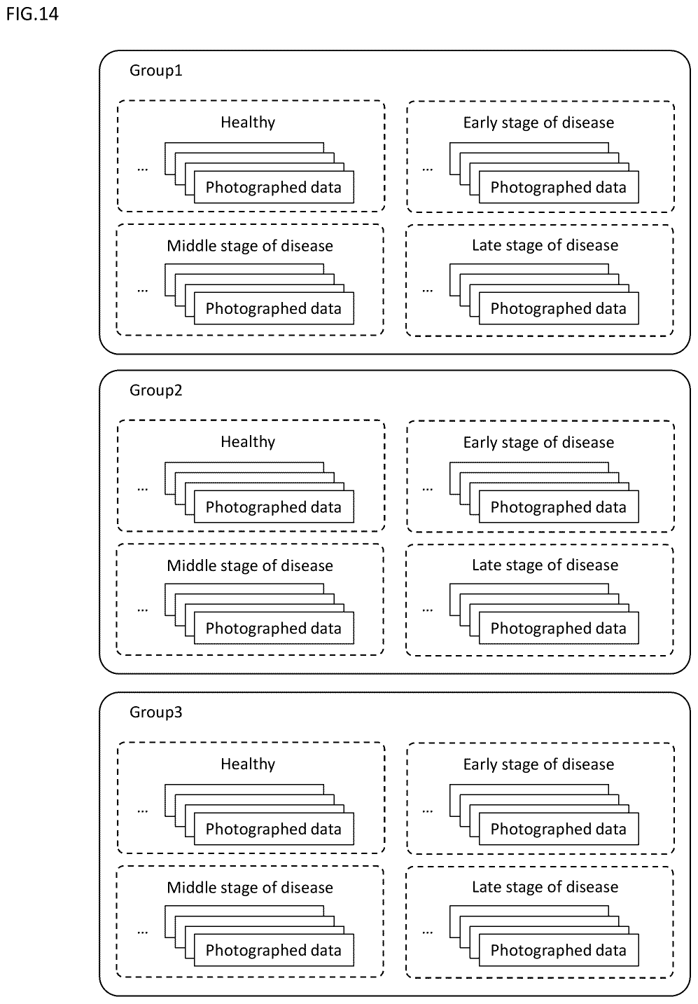

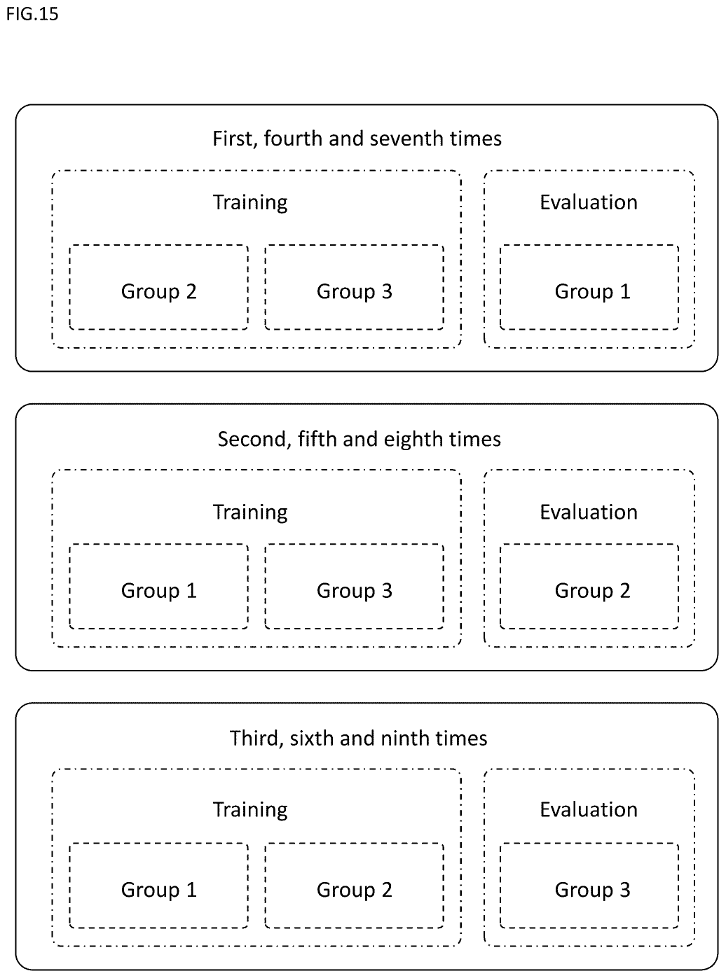

As shown in FIG. 11, in the generation device 1A according to the second exemplary embodiment, the arithmetic circuit 11 is implemented by an information processing device including an input device 12, an output device 13, a communication circuit 14, and a storage device 15. As shown in FIG. 14, the storage device 15 of the generation device 1A according to the second exemplary embodiment stores a clustering program P3, a generation program P1, photographed data D11, light intensity data D12, clustering data D31, clustering result data D32, training data D13, and a discriminant model M.

The clustering program P3 is a computer program executed by the arithmetic circuit 11. By executing the clustering program P3, clustering processing is executed in the generation device 1A. The clustering program P3 generates a cluster by using hard clustering such as hierarchical clustering and non-hierarchical clustering or soft clustering, for example.

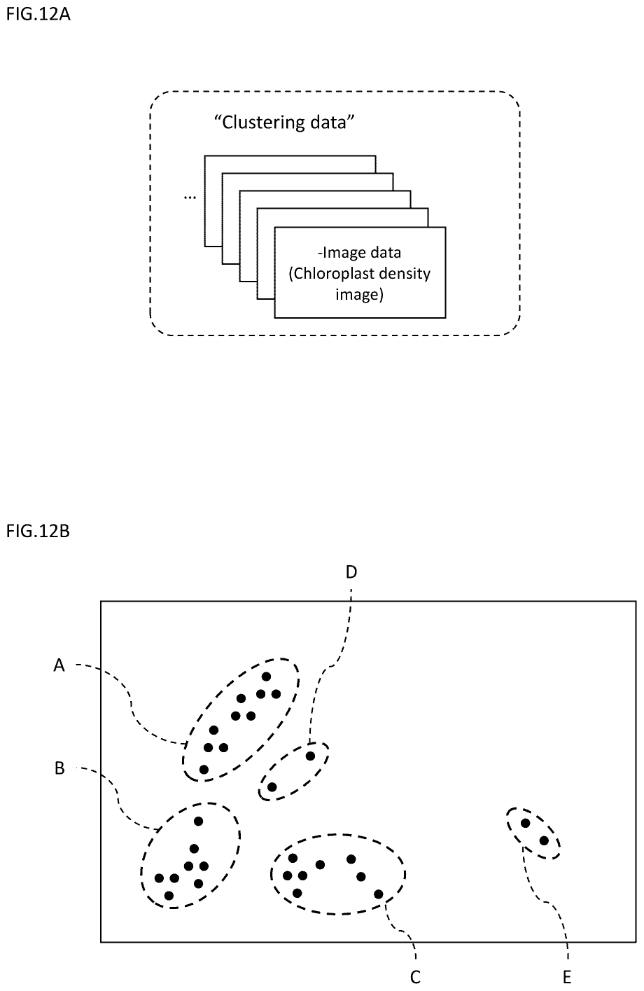

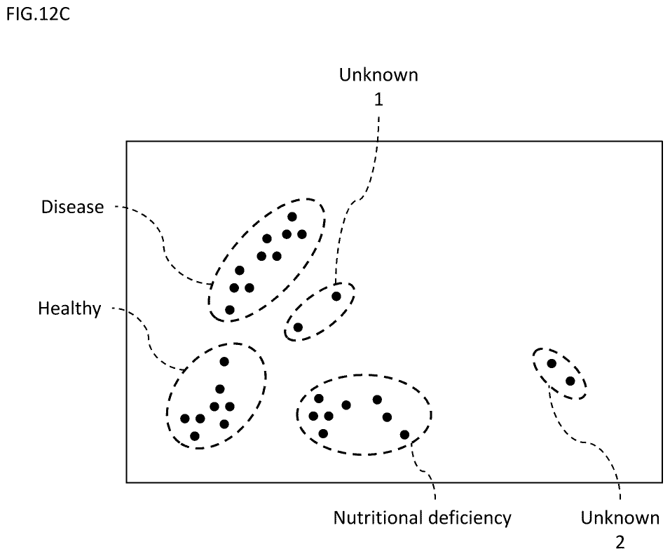

As shown in FIG. 12A, the clustering data D31 is data including a mere image to which no flag is attached. The clustering data may be, for example, chloroplast density images generated from the plurality of respective pieces of photographed data D11.

The clustering result data D32 is a result of clustering the clustering data D31. For example, as shown in FIG. 12B, a plurality of clusters are obtained from the clustering data D31 by unsupervised learning, and become clustering result data D32. For example, FIG. 12B shows an example in which clusters A to E are obtained using hard clustering in which one piece of data belongs only to one cluster. It should be noted that, when soft clustering that allows one piece of data to belong to a plurality of clusters is used, for example, a label of a plurality of items of “disease damage and nutritional deficiency” may be given. In addition, evaluation may be performed up to a relative distribution of a plurality of labels. In general, natural phenomena including leaf yellowing are manifested by composite factors.

The training data D13 is data generated by labeling each of the clusters A to E of the clustering result data D32 by the user. The training data D13 is used for generating the discriminant model M. FIG. 12C is an example in which the clusters A to C obtained in FIG. 12B are labeled with “disease”, “healthy”, and “nutritional deficiency”, respectively. It should be noted that labels of all clusters may not be able to be identified. If being unable to be identified, the label “unknown” may be attached as shown in FIG. 12C. In addition, for example, there may be a case where there are a plurality of patterns of ways of expressing disease damage, such as citrus greening disease, or there may be a case where there are a plurality of gene lineages of pathogenic bacteria. In such a case, for example, a cluster of “disease” labels may be subdivided and stratified as “disease pattern A” and “disease pattern B”. It should be noted that the subdivision and stratification of the label are not limited to the “disease” label.

### <Processing of Clustering and Generating Discriminant Model>

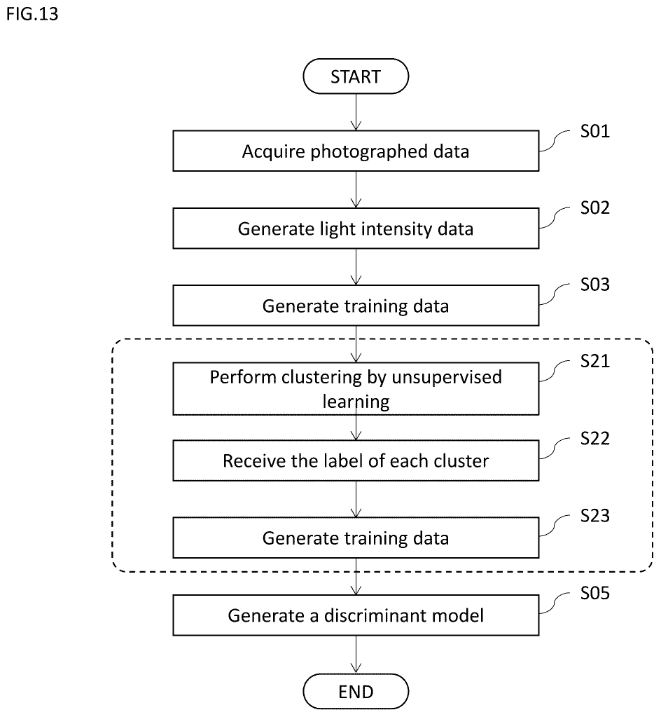

Processing of clustering and generating the discriminant model M executed by the generation device 1A will be described with reference to a flowchart shown in FIG. 13. Specifically, the processing in broken lines (S21 to S23) in the flowchart shown in FIG. 13 is the clustering processing.

First, the arithmetic circuit 11 acquires photographed data D11 of leaves of a plurality of plants (S01). The arithmetic circuit 11 stores the acquired plurality of pieces of photographed data D11 in the storage device 15. It should be noted that, in the generation device 1A, since a label is attached after clustering, no label is attached in step S01.

The arithmetic circuit 11 generates light intensity data D12 using photographed data D11 acquired in step S01 (S02). The generation method for the light intensity data D12 is similar to that of the generation device 1 according to the first exemplary embodiment. In addition, the arithmetic circuit 11 stores the generated light intensity data D12 in the storage device 15.

The arithmetic circuit 11 generates a chloroplast density image using light intensity data D12 generated in step S02 (S03). The generation method for the chloroplast density image is similar to that of the generation device 1 according exemplary embodiment. In addition, the arithmetic circuit 11 stores the generated plurality of chloroplast density images in the storage device 15 as the clustering data D31.

The arithmetic circuit 11 performs clustering by unsupervised learning using the clustering data D31 stored in step S03 (S21). The arithmetic circuit 11 stores the result of clustering in the storage device 15 as clustering result data D32.

The arithmetic circuit 11 receives the label of each cluster obtained in step S21 (S22). For example, the label of each cluster is input by the user through the input device 12.

The arithmetic circuit 11 associates the corresponding label received in step S22 with each chloroplast density image of the clustering data D31, and generates the training data D13 (S23). In addition, the arithmetic circuit 11 stores the generated training data D13 in the storage device 15.

The arithmetic circuit 11 generates a discriminant model M using training data D13 generated in step S04 (S05). The generation method for the discriminant model M is similar to that of the generation device 1 according to the first exemplary embodiment. In addition, the arithmetic circuit 11 stores the generated discriminant model M in the storage device 15.

In this manner, the generation device 1A performs clustering from the image of the leaf of the plant. In addition, the generation device 1A can generate a discriminant model M for discriminating the growth state of a leaf of a plant using a result of clustering.

It should be noted that, in the above description, an example has been described in which the generation device 1A executes all of the generation of the chloroplast density image, the clustering, and the generation of the discriminant model M. However, some pieces of processing may be executed by another information processing device. In addition, each piece of processing may be executed by different information processing devices. For example, clustering may be performed using a chloroplast density image generated by another information processing device. In addition, clustering and generation of the discriminant model M may be executed by different information processing devices.

The discrimination by the discriminant model M generated as described above in the second exemplary embodiment is executed similarly to the description described above in the first exemplary embodiment. It should be noted that in FIG. 12C, an example in which each cluster is labeled with “disease”, “healthy”, “nutritional deficiency”, “unknown 1”, and “unknown 2” has been described. In the discriminant model M generated by the training data D13 generated in this manner, the discrimination result may be “unknown” in addition to “disease”, “healthy”, or “nutritional deficiency”. In addition, when a label to be attached to a cluster that has been “unknown” is found later, a correct label may be attached. Accordingly, the discriminant model M can more accurately discriminate.

### First Modification

In the first exemplary embodiment described above, an example of discriminating whether being healthy or a disease in which yellowing has occurred has been described. In addition, discrimination has been performed using a discriminant model learned using a label indicating whether the disease is in the early stage of disease, the middle stage of disease, or the late stage of disease among diseases. However, as a matter of course, the discriminant model may use training data to which labels other than these are attached. For example, the discriminant model may be generated using training data labeled such as “nutritional deficiency” or “overwatering” in addition to the above labels or instead of the above labels.

### Second Modification

In the above example, the leaf orientation in the photographed data is not mentioned. On the other hand, there is a plant in which the orientation of the leaf vein is easily understood, such as a bamboo leaf. In such a case, the discrimination accuracy can be improved by adjusting the orientation of the leaf to a predetermined orientation using the training data and the discrimination data.

### Third Modification

In the second modification, the orientation of the leaf is adjusted regarding the plant in which the orientation of the leaf vein is easily understood. However, in the case of the leaf in which the direction of the leaf vein is not aligned, the number of training data may be increased by rotating one piece of photographed data. By learning the image data rotated with respect to one piece of photographed data in this manner, it is possible to perform discrimination without depending on the photographing orientation of the leaf, and it is possible to facilitate photographing of photographed data for discrimination. Furthermore, even if gradation is applied in the image, learning can be performed without depending on the directionality of the gradation. Therefore, over-training due to gradation of the training data can be prevented, and the accuracy of discrimination can be improved.

### Fourth Modification

In the above example, the photographed data D11 has been described as an example of photographing using the “transmission type optical system having substantially uniform luminance”. However, the photographing optical system used for photographing the photographed data D11 is not limited to the transmission type optical system. Specifically, the photographed data D11 can be data that can separate a yellowing portion, a healthy portion, and a leaf-vein portion. In addition, the photographing optical system used for photographing the photographed data D11 may be a photographing optical system capable of photographing under a uniform condition in each sample. For example, in addition to the transmission type optical system that is portable outdoors in the field, a photographing optical system in which an indoor photographing environment is uniformly arranged may be used.

### Other Modifications

In the above-described example, an example of discriminating the state of a plant by machine learning has been described, but the generative AI can be implemented using, for example, generative adversarial networks based on the same training data. Specifically, an RGB image of a leaf is restored in a pseudo manner by training a chloroplast density image, generating a non-existent chloroplast density image under any condition, and coloring a portion having a high pixel value to a portion having a low pixel value from yellow to green, for example. Such generative AI can generate a desired conditional image such as a virtual “healthy” leaf image, or a virtual “early stage of disease+middle stage of nutritional deficiency” leaf image. By using such generative AI, for example, in the case of citrus greening disease, when citrus fruits in an area where the disease has not spread yet are affected with the disease, it is possible to predict what kind of yellowing aspect it will be, which can be useful for early detection.

### Experimental Example 1

An experimental result of the generation of the above-described discriminant model M will be described below. In the experiment, 841 pieces of photographed data including healthy plant leaves and diseased plant leaves were prepared. Each piece of photographed data is an image photographed using a transmission type optical system incorporating a surface light source having substantially uniform luminance with respect to a surface. Plants are leaves of citrus plants such as shikuwasa, and the disease is the citrus greening disease. As shown in FIG. 14, each piece of photographed data is labeled with any one of “healthy”, “early stage of disease”, “middle stage of disease”, and “late stage of disease”. In addition, the photographed data was divided into group 1 (early photographing), group 2 (middle photographing), and group 3 (late photographing) for each photographing time, and the training data and the evaluation data were selected and evaluated from each group. It should be noted that groups were created so that images of the same leaf were not included in different groups.

As shown in FIG. 15, in different combinations, training and evaluation were performed 3 times and repeated 3 times. Specifically, in the first training, training was executed based on the photographed data of the group 2 and the group 3, and evaluation was performed based on the photographed data of the group 1. In addition, in the second training, training was executed based on the photographed data of the group 1 and the group 3, and evaluation was performed based on the photographed data of the group 2. In the third training, training was executed based on the photographed data of the group 1 and the group 2, and evaluation was performed based on the photographed data of the group 3. In the fourth time and the seventh time, evaluation was performed in the same set as the first time. In the fifth time and the eighth time, evaluation was performed in the same set as the second time. In the sixth time and the ninth time, evaluation was performed in the same set as the first time.

Specifically, generation and verification of the discriminant model were performed using images obtained from various pieces of processing or calculation results. Here, among them, in addition to the photographed data itself (Table 3.1), a result with high evaluation accuracy is shown. Specifically, the results of generating and verifying the discriminant model using the image (R image−B image) calculated with the R image and the B image (Table 3.2), the image (G image−B image) calculated with the G image and the B image (Table 3.3), the image (Table 3.4) obtained by (G image+R image)/2−B image, and the image (Table 3.5) obtained by rotating the image in Table 3.3 by every 45° and increasing by 8 times are shown.

In the following tables, “early stage of disease” is simply referred to as “early stage”, “middle stage of disease” is simply referred to as “middle stage”, and “late stage of disease” is simply referred to as “late stage”.

In addition, in the following description, the “correct answer rate” is a correct answer rate of the classification result classified into each label from the early stage to the middle stage of the disease. In addition, the “disease damage leaf correct answer rate” is a correct answer rate of the classification result of whether to be healthy or diseased. For example, the boundary between the early stage and middle stage of disease is ambiguous. In addition, the boundary between the middle stage and late stage of disease is ambiguous. Therefore, the early stage to the late stage of disease are regarded as one discrimination result of “disease”, and if classified into any one of them, it is a correct answer rate when it is considered as correct. Hereinafter, for the sake of simplicity of description, it is described assuming that “the accuracy of the evaluation result is improved” when both the “disease damage leaf correct answer rate” and the “correct answer rate” tend to be increased centering on the “disease damage leaf correct answer rate”.

Furthermore, the following results indicate the sum of the results of the first to ninth trainings and evaluations performed in the combination shown in FIG. 15.

TABLE 3.1

| | | | | | | DISEASE |
|---|---|---|---|---|---|---|
| | | | | | | DAMAGE |
| | | | | | | LEAF |
| | CLASSIFICATION RESULT | | | | CORRECT | CORRECT |
| | | EARLY | MIDDLE | LATE | ANSWER | ANSWER |
| LABEL | HEALTHY | STAGE | STAGE | STAGE | RATE | RATE |
| HEALTHY | 830 | 49 | 84 | 42 | 82.6% | 82.6% |
| EARLY | 75 | 238 | 176 | 18 | 46.9% | 85.2% |
| STAGE | | | | | | |
| MIDDLE | 103 | 119 | 430 | 59 | 60.5% | 85.5% |
| STAGE | | | | | | |
| LATE | 39 | 24 | 122 | 115 | 38.3% | 87.0% |
| STAGE | | | | | | |
| TOTAL | 1047 | 430 | 812 | 234 | 63.9% | 84.5% |

Table 3.2 shows an example in which training and evaluation are performed using an image obtained by applying the following Expression (2.1) for each pixel using the R image and the B image obtained from the photographed data.

R image−B image (2.1)

The accuracy of the evaluation result is improved as compared with the case of the photographed data in Table 3.1.

TABLE 3.2

| | | | | | | DISEASE |
|---|---|---|---|---|---|---|
| | | | | | | DAMAGE |
| | | | | | | LEAF |
| | CLASSIFICATION RESULT | | | | CORRECT | CORRECT |
| | | EARLY | MIDDLE | LATE | ANSWER | ANSWER |
| LABEL | HEALTHY | STAGE | STAGE | STAGE | RATE | RATE |
| HEALTHY | 840 | 84 | 65 | 16 | 83.6% | 83.6% |
| EARLY | 122 | 254 | 122 | 9 | 50.1% | 75.9% |
| STAGE | | | | | | |
| MIDDLE | 85 | 116 | 473 | 37 | 66.5% | 88.0% |
| STAGE | | | | | | |
| LATE | 22 | 24 | 109 | 145 | 48.3% | 92.7% |
| STAGE | | | | | | |
| TOTAL | 1069 | 478 | 769 | 207 | 67.9% | 84.4% |

Table 3.3 shows an example in which training and evaluation are performed using an image obtained by applying the following Expression (2.2) for each pixel using the G image and the R image obtained from the photographed data.

G image−B image (2.2)

The accuracy of the evaluation result is improved as compared with the case of the photographed data in Table 3.1.

TABLE 3.3

| | | | | | | DISEASE |
|---|---|---|---|---|---|---|
| | | | | | | DAMAGE |
| | | | | | | LEAF |
| | CLASSIFICATION RESULT | | | | CORRECT | CORRECT |
| | | EARLY | MIDDLE | LATE | ANSWER | ANSWER |
| LABEL | HEALTHY | STAGE | STAGE | STAGE | RATE | RATE |
| HEALTHY | 891 | 58 | 23 | 33 | 88.7% | 88.7% |
| EARLY | 78 | 312 | 106 | 11 | 61.5% | 84.6% |
| STAGE | | | | | | |
| MIDDLE | 78 | 135 | 427 | 71 | 60.1% | 89.0% |
| STAGE | | | | | | |
| LATE | 28 | 20 | 79 | 173 | 57.7% | 90.7% |
| STAGE | | | | | | |
| TOTAL | 1075 | 525 | 635 | 288 | 71.5% | 88.2% |

Table 3.4 shows an example in which training and evaluation are performed using images obtained by the following Expression (2.3) for each pixel using the G image and the R image obtained from the photographed data.

$$( G image + R image ) / 2 - B image \qquad ( 2.3 )$$

Expression (2.3) is a case where the values of x and y in the above Expression (1.3) are (1,1).

The accuracy of the evaluation result is improved as compared with the case of the photographed data in Table 3.1.

TABLE 3.4

| | | | | | | DISEASE |
|---|---|---|---|---|---|---|
| | | | | | | DAMAGE |
| | | | | | | LEAF |
| | CLASSIFICATION RESULT | | | | CORRECT | CORRECT |
| | | EARLY | MIDDLE | LATE | ANSWER | ANSWER |
| LABEL | HEALTHY | STAGE | STAGE | STAGE | RATE | RATE |
| HEALTHY | 851 | 75 | 57 | 22 | 84.7% | 84.7% |
| EARLY | 97 | 286 | 115 | 9 | 56.4% | 80.9% |
| STAGE | | | | | | |
| MIDDLE | 88 | 121 | 447 | 55 | 62.9% | 87.6% |
| STAGE | | | | | | |
| LATE | 20 | 20 | 98 | 162 | 54.0% | 93.3% |
| STAGE | | | | | | |
| TOTAL | 1056 | 502 | 717 | 248 | 69.2% | 85.8% |

Table 3.5 shows an example in which training and evaluation were performed using images obtained by rotating the image obtained by the above-described Expression (2.2) by every 45° and increasing the image by 8 times.

The accuracy of the evaluation result is improved as compared with the case of the photographed data in Table 3.1. In addition, it can be seen that the evaluation results shown in Table 3.5 have higher accuracy than all the other evaluation results in Tables 3.2 to 3.4 described above.

TABLE 3.5

| | | | | | | DISEASE |
|---|---|---|---|---|---|---|
| | | | | | | DAMAGE |
| | | | | | | LEAF |
| | CLASSIFICATION RESULT | | | | CORRECT | CORRECT |
| | | EARLY | MIDDLE | LATE | ANSWER | ANSWER |
| LABEL | HEALTHY | STAGE | STAGE | STAGE | RATE | RATE |
| HEALTHY | 874 | 36 | 66 | 29 | 87.0% | 87.0% |
| EARLY | 71 | 248 | 174 | 14 | 48.9% | 86.0% |
| STAGE | | | | | | |
| MIDDLE | 34 | 91 | 544 | 42 | 76.5% | 95.2% |
| STAGE | | | | | | |
| LATE | 14 | 20 | 76 | 190 | 63.3% | 95.3% |
| STAGE | | | | | | |
| TOTAL | 993 | 395 | 860 | 275 | 73.6% | 90.1% |

### Experimental Example 2

In Experimental Example 2, images of a hue (H) image, a saturation(S) image, a brightness (V) image, an R image, a G image, and a B image were used. Also in Experimental Example 2, in the group shown in FIG. 14, training and evaluation were repeated 9 times in total as shown in FIG. 15, and the results were summed up. In addition, in Experimental Example 2, the results were compared with the results in Table 3.5 in which the accuracy of the evaluation results was the highest in Experiment 1. The evaluation results of any of the H image, the S image, the V image, the R image, the G image, and the B image are lower in accuracy than the results in Table 3.5. As an example, only the evaluation result of the H image will be described below.

Table 4 shows an example in which training and evaluation were performed on an image obtained by converting photographed data of a color image into a hue image. The accuracy of the evaluation result is lower than that in the case of Table 3.5. In addition, the disease damage leaf correct answer rate is deteriorated as a whole as even compared with the result of Table 3.1 which is the original image.

TABLE 4

| | | | | | | DISEASE |
|---|---|---|---|---|---|---|
| | | | | | | DAMAGE |
| | | | | | | LEAF |
| | CLASSIFICATION RESULT | | | | CORRECT | CORRECT |
| | | EARLY | MIDDLE | LATE | ANSWER | ANSWER |
| LABEL | HEALTHY | STAGE | STAGE | STAGE | RATE | RATE |
| HEALTHY | 782 | 70 | 133 | 20 | 77.8% | 77.8% |
| EARLY | 136 | 263 | 103 | 5 | 51.9% | 73.2% |
| STAGE | | | | | | |
| MIDDLE | 176 | 72 | 435 | 28 | 61.2% | 75.2% |
| STAGE | | | | | | |
| LATE | 38 | 4 | 96 | 162 | 54.0% | 87.3% |
| STAGE | | | | | | |
| TOTAL | 1132 | 409 | 767 | 215 | 65.1% | 77.3% |

In the H image, since the information on the dead part of the leaf was treated equally to other yellowing portion and healthy portion, it is considered that the evaluation result was deteriorated. Accordingly, it can be seen that yellowing is a difference in tint, but that the accuracy of discrimination is not increased by using a discriminant model using an H image showing a difference in tint. In addition, it can also be seen that a discriminant model using the image obtained by Expression (1.3) is useful.

### Experimental Example 3

In Experimental Example 3, the transition of the discrimination accuracy when the values of x and y in Expression (1.3) were changed was evaluated. Experimental Example 3 is the discrimination accuracy when the image obtained by Expression (1.3) is generated from the image used in Experimental Example 1 and the discriminant model is generated. Table 5 shows the results of Experimental Example 3. Table 5 shows representative values of the disease damage leaf correct answer rates when the ratio (x/(x+y)) of R in R:G takes each value. The representative value of the disease damage leaf correct answer rate is a numerical value of the sum of the disease damage leaf correct answer rates.

TABLE 5

| | REPRESENTATIVE VALUE OF DISEASE |
|---|---|
| x/(x + y) | DAMAGE LEAF CORRECT ANSWER RATE |
| 0.0 | 88.5% |
| 0.1 | 87.8% |
| 0.2 | 87.9% |
| 0.3 | 87.5% |
| 0.4 | 86.8% |
| 0.5 | 86.3% |
| 0.6 | 86.1% |
| 0.7 | 86.0% |
| 0.8 | 85.9% |
| 0.9 | 85.9% |
| 1.0 | 85.6% |

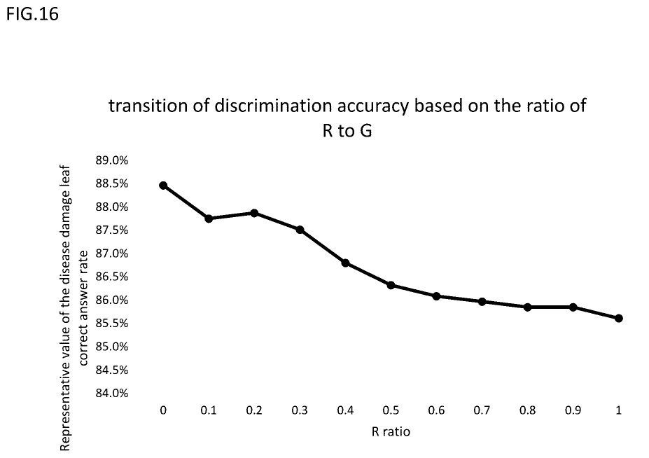

In addition, the results of Table 5 are shown in FIG. 16. From the tendency of the graph shown in FIG. 16, it can be seen that the lower the ratio of R, the higher the accuracy of discrimination. x=0 and y=1 at which the discrimination accuracy is the highest may be adopted. In addition, for example, as the values of x and y, x=0.15 and y=0.85, where the accuracy of discrimination is 87% or more and the ratio of R is the average value of 0.0 to 0.3, may be adopted.

(1) A generation method of the present disclosure is a generation method for a discriminant model for discriminating a growth state of a plant executed by a computer including an arithmetic circuit configured to access a storage device, the generation method including:
storing, by the storage device, a chloroplast density image which is an image reflecting a difference between absorption spectra of chlorophyll and carotenoids contained in the plant obtained from a plurality of images of leaves of plants for training;
being executed by the arithmetic circuit;
reading the chloroplast density image from the storage device; and
generating a discriminant model of a growth state of a plant using the chloroplast density image as training data for machine learning.

(2) In the generation method according to (1), the chloroplast density image may be an image obtained by the following Expression (1) for each value of corresponding pixel using two or more among an R image, a G image, and a B image obtained from an image of a leaf of a plant:

(Expression for blending R image and G image with any weighting)−(Expression using B image) (1),
where in the Expression (1), a pixel value of an image that is not used among the R image, the G image, and the B image may be 0.

(3) In the generation method according to (2), the Expression (1) may be the following Expression (2).

$$( R image \times x + G image \times y ) / ( x + y ) - B image , \qquad ( 2 )$$

$$( where 0 \leq x , 0 \leq y )$$

(4) In the generation method according to (1) to (3), a growth state of the plant may include at least one selected from a group including a healthy state, a disease damage affected state, a nutritional deficiency or excess state, a poor growth environment state, and an insect-damage state.

(5) In the generation method according to (1) to (4), a selected level among levels of different degrees may be included.

(6) In the generation method according to (3), a step of optimizing values of x and y in the Expression (2) to a combination having highest discrimination accuracy may be included.

(7) In the generation method according to (1) to (6), a transmission type optical system incorporating a surface light source having luminance substantially uniform with respect to a surface may be used to acquire an image of a leaf of the plant.

(8) In the generation method according to (1) to (7), the machine learning may include at least one type of supervised learning and unsupervised learning.

(9) In the generation method according to (1) to (8), the storage device may store each of the chloroplast density images in association with a label indicating a state of the plant, and
the arithmetic circuit may
   read the label together with the chloroplast density image from the storage device as training data for supervised learning,
   learn a relationship between a plurality of the chloroplast density images included in the training data and the corresponding label by machine learning, and
   generate a discriminant model that outputs, with respect to a chloroplast density image of a new plant, a state of the new plant as a discrimination result.

(10) In the generation method according to (1) to (9), the arithmetic circuit may
read a plurality of the chloroplast density images from the storage device as training data for unsupervised learning,
generate a plurality of clusters for each characteristic of a state of a plant based on an analysis result of characteristics of the plurality of chloroplast density images of the training data, and
generate a discriminant model in which when a label indicating a state of the plant is given to each cluster, the plurality of chloroplast density images included in the cluster and a label given to the cluster are set as training data for supervised learning, a relationship between the plurality of density chloroplast images and the corresponding label is learned, and, with respect to a chloroplast density image of a new plant, a state of the new plant is output as a discrimination result.

(11) A discrimination method of the present disclosure is a discrimination method for discriminating a state of a plant executed by a computer including an arithmetic circuit configured to access a storage device, the discrimination method including:
being executed by the arithmetic circuit;
reading an image of a leaf of a plant for discrimination from the storage device;
calculating, from the image, a chloroplast density image indicating density of a chloroplast of a plant; and
discriminating a state of the plant by using the calculated chloroplast density image as an input to the discriminant model generated by the generation method according to claim 1.

(12) A computer program of the present disclosure executes the generation method according to any one of (1) to (10).

(13) The computer program of the present disclosure executes the discrimination method according to (11).

(14) A generation device of the present disclosure is a generation device including an arithmetic circuit configured to access a storage device, the generation device generating a discriminant model for discriminating a state of a plant, in which the storage device stores a chloroplast density image which is an image reflecting a difference between absorption spectra of chlorophyll and carotenoids contained in the plant obtained from a plurality of images of leaves of plants for training, and the arithmetic circuit reads the chloroplast density image from the storage device, and generates a discriminant model of a growth state of a plant using the chloroplast density image as training data for machine learning.

What is claimed is:

1. A generation method for a discriminant model for discriminating a growth state of a plant executed by a computer including a processor configured to access a storage device, the generation method comprising:
storing, by the storage device, a plurality of chloroplast density image which are obtained by using the following formula (1) for each pixel of the images using the images of the leaves of the plurality of plants;
$$( intensity of red light \times x + G image indicating the intensity of green light \times y ) \text{} / ( x + y ) - intensity of blue light , \qquad ( 1 )$$
(where 0≤x, 0≤y and except x=y=0)
being executed by the processor;
reading the plurality of chloroplast density image from the storage device; and
generating a discriminant model of the growth state of the plant using the plurality of chloroplast density image as training data for machine learning,
further the circuit optimizing values of x and y in the Expression (1) to a combination having highest discrimination accuracy.

2. The generation method according to claim 1, wherein the growth state of the plant includes at least one selected from a group including a healthy state, a disease damage affected state, a nutritional deficiency or excess state, a poor growth environment state, and an insect-damage state.

3. The generation method according to claim 1, wherein the growth state includes a selected level among levels of different degrees.

4. The generation method according to claim 1, wherein a transmission type optical system incorporating a surface light source having luminance substantially uniform with respect to a surface is used to acquire an image of a leaf of the plant.

5. The generation method according to claim 1, wherein the machine learning includes at least one type of supervised learning and unsupervised learning.

6. The generation method according to claim 1, wherein
the storage device stores each of the chloroplast density images in association with a label indicating the growth state of the plant, and
the processor
reads the label together with the chloroplast density image from the storage device as training data for supervised learning,
learns a relationship between a plurality of the chloroplast density images included in the training data and the corresponding label by machine learning, and
generates a discriminant model that outputs, with respect to a chloroplast density image of a new plant, a growth state of the new plant as a discrimination result.

7. The generation method according to claim 1, wherein the processor
reads a plurality of the chloroplast density images from the storage device as training data for unsupervised learning,
generates a plurality of clusters for each characteristic of the growth state of the plant based on an analysis result of characteristics of the plurality of chloroplast density images of the training data, and
generates a discriminant model in which when a label indicating the growth state of the plant is given to each cluster, the plurality of chloroplast density images included in the cluster and a label given to the cluster are set as training data for supervised learning, a relationship between the plurality of chloroplast density images and the corresponding label is learned, and, with respect to a chloroplast density image of a new plant, a growth state of the new plant is output as a discrimination result.

8. A discrimination method for discriminating a growth state of a plant executed by a computer including a processor configured to access a storage device, the discrimination method comprising:
being executed by the processor;
reading an image of a leaf of a plant for discrimination from the storage device;
calculating, from the image, a chloroplast density image indicating density of a chloroplast of a plant; and
discriminating the growth state of the plant by using the calculated chloroplast density image as an input to the discriminant model generated by the generation method according to claim 1.

9. A generation device comprising a processor configured to access a storage device, the generation device generating a discriminant model for discriminating a growth state of a plant,
wherein
the storage device stores a plurality of chloroplast density image which are obtained by using the following formula (1) for each pixel of the images using the images of the leaves of the plurality of plants,
$$( intensity of red light \times x + G image indicating the intensity of green light \times y ) \text{} / ( x + y ) - intensity of blue light , \qquad ( 1 )$$
(where 0≤x, 0≤y and except x=y=0), and
the processor
reads the plurality of chloroplast density image from the storage device, and
generates a discriminant model of the growth state of the plant using the plurality of chloroplast density image as training data for machine learning,
further the processor optimizes values of x and y in the Expression (1) to a combination having highest discrimination accuracy.
